(19) United States
(12) Patent Application Publication
(10) Pub. No.: US 2017/0305499 A1
(43) Pub. Date: Oct. 26, 2017

(54) ADJUSTABLE FRICTION RING TRANSMISSION FOR A VEHICLE OPERABLE USING MOTOR POWER AND/OR PEDAL POWER

(71) Applicant: Robert Bosch GmbH, Stuttgart (DE)

(72) Inventors: Markus Hinterkausen, Moeglingen (DE); Juergen Hilzinger, Renningen (DE); Peter Kimmich, Steinenbronn (DE)

(21) Appl. No.: 15/517,119

(22) PCT Filed: Sep. 15, 2015
(86) PCT No.: PCT/EP2015/071065

§ 371 Date: Apr. 5, 2017

(30) Foreign Application Priority Data
Oct. 23, 2014 (DE) 10 2014 221 514.5

(51) Int. Cl. B62M 11/14; B62M 6/55; F16H 15/52; F16H 37/02

(52) U.S. Cl. CPC B62M 11/145; F16H 37/022; B62M 6/55; F16H 15/52

(57) ABSTRACT

A friction ring transmission for a vehicle operable using motor power and/or pedal power, including a crankshaft for pedal cranks, in particular, for an electric bicycle, the friction ring transmission including an inner friction ring and an outer friction ring, and at least one rotatable double tapered roller situated on a roller carrier, which frictionally engages with the inner friction wheel and the outer friction ring, in each case with a contact force, when a torque is transmitted via the friction ring transmission, a force return device for transmitting a contact force from one friction ring to the other friction ring being situated in a power flow path from the inner friction ring to the outer friction ring, one of the friction rings being rotatably fixedly situated in relation to the force return device and the other friction ring being rotatably situated in relation to the force return device.

### BACKGROUND INFORMATION

The present invention relates to a friction ring transmission for a vehicle operable using motor power and/or pedal power, including a crankshaft for pedal cranks and including a crankshaft center axis, which is to be understood as a theoretical axis and not as a fixed physical axis, the friction ring transmission being capable of being used, in particular, in an electric bicycle. The friction ring transmission includes an inner friction ring and an outer friction ring and at least one rotatable double tapered roller, which frictionally engages the inner friction ring and the outer friction ring. When a torque is transmitted, a contact force is transmitted in each case for the purpose of producing friction between the double tapered roller and the friction rings. Since these contact forces act on the double tapered roller at least partially in the opposite direction, a power flow path exists between the inner friction ring and the outer friction ring, along which contact forces are conducted from the one friction ring to the other friction ring. Situated within this power flow path is a force return device for transmitting contact force from one friction ring to the other friction ring. One of the friction rings is fixedly situated in relation to the force return device. The other friction ring is rotatable in relation to the force return device.

In vehicles, in particular, conventional electric bicycles, drive is possible both using muscle power as well as motor power and, in particular, using motor-assisted muscle power. Since there is an optimum range for the pedaling frequency of the rider and the possible pedaling frequency is upwardly limited, transmissions on such vehicles are advantageous, because with them, the pedaling frequency may be brought into the optimal or possible range. Friction ring transmissions have the advantage that they are adjustable continuously and also when stationary. The disadvantage of friction ring transmission, however, is the comparatively poor efficiency, which is caused both by the friction processes as well as by the transmission components such as, for example, bearings. A bicycle transmission based on the fundamental principle of the double cone friction ring transmission is described in German Patent Application No. DE 2012 209 0696 A1, which is integrated near the pedal bearing and situated axially in parallel to the crankshaft in a pedelectric/eBike drive. In PCT Application No. WO 2014/026 754 A1, a bicycle transmission is described which includes such a double cone friction ring transmission also situated axially in parallel to the crankshaft and near the pedal bearing.

A disadvantage of the design of the friction ring transmission described in German Patent Application No. DE 10 2012 209 096 A1 is that the force return device, which enables the friction rings to be pressed against the double cones, extends on the outside around the friction ring transmission. As a result, the force return device is a part having a large surface and is correspondingly heavy, which runs contrary to the lightweight concept applicable to vehicles in general.

Conventional transmissions also have the disadvantage that the adjustment of the gear ratio is carried out exclusively by the inside of the drive shaft or output shaft of the friction ring transmission and as thread adjustment. This significantly hampers the design freedom in the integration of such a transmission into a vehicle; in particular, adjustment requires a rotational movement of several rotations to be generated. In addition, this rotational movement is locally fixed at a center position in relation to the transmission. Even the rotation axis of the adjustment rotation is permanently predefined and extends coaxially to the center axis of the transmission.

### SUMMARY

The friction ring transmission according to the present invention includes, for example, an adjusting device for the gear ratio of the friction ring transmission, which is movable along an adjustment path. The adjustment path has a component of its course in the direction of a center axis of the roller carrier, the component at the same time extending at most less than a full rotation about the friction ring transmission, preferably less than 180 degrees, particularly preferably less than 90 degrees. The adjustment path extends particularly preferably straight and follows the direction of an imaginary center axis of the friction ring transmission. This center axis normally coincides with the center axis of a roller carrier of the double tapered rollers.

The adjusting device preferably penetrates a housing surrounding the friction ring transmission. The adjustment path extends preferably along a recess in the housing. Therefore, it is advantageous that the adjustment path extends circumferentially less than 360 degrees, preferably less than 180 degrees, more preferably less than 90 degrees. The housing may then be manufactured in particular, as a single piece, which is generally less costly than a multi-piece composite approach. The housing is particularly strong if at least a half rotation of the housing is not breached by the adjustment path. Less than a 90 degree circumferential extension of the adjustment path about the friction ring transmission has the advantage that the adjustment is simplified by the smaller encompassing angle. A particularly simple adjustment is achieved by a purely linear movement generally in the direction of the center axis of the roller carrier. The adjusting device is particularly preferably non-rotatably connected to the roller carrier, i.e., it is not movable relative to the roller carrier, so that an actuation of the adjusting device immediately shifts the roller carrier in the axial direction, as a result of which the gear ratio of the friction ring transmission is changed. It is possible that the roller carrier is rotated during adjustment; preferably, however, the roller carrier is not rotated and shifted only linearly. The adjusting device preferably includes no adjustable thread. The adjusting device preferably does not extend through the central area of the friction ring transmission. The adjusting device according to the present invention creates the possibility of rapidly and simply setting the gear ratio of the friction ring transmission.

The inner friction ring and the outer friction ring extend preferably around the crankshaft. This makes it possible to situate the crankshaft in the center of the friction ring transmission. The friction ring transmission is preferably filled with a traction fluid, which has good lubricating properties and nevertheless creates a high friction between the friction partners during intensive friction contact.

A friction ring transmission including the adjusting device according to the present invention is particularly preferably installed on the pedal bearing. An integrated design of the pedal bearing and the motor is also preferred. This results in the advantages of an optimal mass distribution, which is achieved by a low, central center of gravity and a lightweight rear wheel. The results are an improved handling, minimal spring-loaded masses and good driving dynamics. In addition, the assembly and disassembly of the rear wheel is simplified. Moreover, the bicycle manufacturer is only required to install one single integrated drive unit in the bicycle instead of multiple separate components. The customer may be presented with a uniform module made up of gear ratio control and drive control.

Preferred refinements of the present invention are described herein.

In one specific embodiment, the force return device extends inside the friction rings. This reduces weight as compared to the conventional force return device according to the related art, which extends outside the friction rings. At least one section of the force return device extends preferably in the direction of the center axis of the roller carrier. This section has, in particular, a smaller diameter than the friction diameter of the inner friction ring. It is particularly advantageous in this case, that the force return device according to this specific embodiment extending circumferentially in the inside allows the adjusting device to run from the friction ring support to an opening in the housing. According to the related art, this requisite installation space between the roller holder and the housing is already occupied by the circumferentially extending force return device.

In another specific embodiment, the roller carrier and the housing of the friction ring transmission are rotatably fixedly connected to one another. However, the roller carrier may be shifted relative to the friction wheels. The friction wheels in this case are rotatably designed, but preferably fixed in their position relative to the housing except for this rotation. The adjusting device may be fixedly connected to the roller carrier. It may be fitted as a movable arm, which extends, in particular, from the roller carrier to outside the transmission. The arm in this case extends preferably through the housing. As a result of the rotatably fixed connection to the housing, a course of the adjustment path along the center axis of the transmission or of the roller carrier is possible.

In another specific embodiment, the vehicle is equipped with a servomotor, with which the adjusting device is adjustable. The servomotor may be situated on the friction ring transmission and/or in an integrated unit made up of motor, transmission and crankshaft.

In another specific embodiment, the friction ring transmission includes two expanding clutches, which expand when loaded and increase the contact pressure between the friction rings and the double tapered rollers. Each one of the expanding clutches is preferably assigned to one each of the friction rings. The expanding clutches have an annular design, whereby the power return path extends at least through one of the expanding clutches.

In another specific embodiment, the force return device is situated around the crankshaft for the pedal cranks of the vehicle. The force return device is designed, in particular as a sleeve, the sleeve including a section extending axially along the crankshaft and a section extending radially in the direction of at least one of the friction rings. This design is lightweight and also simple to assemble and therefore easy to manufacture. The radially extending section may be manufactured separately from the axially extending section and joined subsequently, resulting subsequently in an integrated or a composite sleeve.

In another specific embodiment, the interior force return device is designed to be rotatable in relation to the crankshaft. In this way, the rotational speed of a friction ring rotatably fixedly connected to the force return device may differ from the rotational speed of the crankshaft. In this way, the crankshaft may be integrated into the interior of the friction ring transmission.

In another specific embodiment, a pilot transmission is connected in front of the friction ring transmission, which increases the rotational speed of the friction ring transmission. A planetary gear, which is also situated concentrically to the crankshaft, is preferred, in particular, in an integrated assembly, in which the crankshaft extends in the interior of the friction ring transmission. One advantage of the higher rotational speed of the friction ring transmission is that lower torques occur. As a result, the friction force to be transmitted may be reduced. This in turn allows the friction ring transmission to be designed lighter.

A rear transmission is preferably connected behind the friction ring transmission, which is designed preferably as a planetary gear, and which reduces the output rotational speed of the friction wheel transmission at its own output. In this way, the torque at the output is increased. The rear transmission with its reduction ratio may, in particular, again neutralize the gear ratio of the pilot transmission.

The pilot transmission is preferably driven with a torque, which is present on the crankshaft. For this purpose, a gear wheel may be connected to the crankshaft, into which its torque may be transmitted. In the case of a planetary gear as the pilot transmission, it is preferable to rotatably fixedly attach the annulus gear thereof to the crankshaft. As an alternative to a rotatably fixed attachment, a freewheel, which enables a reverse pedaling independently of the rotation of the motor, may also be situated in the course of the torque transmission between the crankshaft and the annulus gear. A friction ring of the friction ring transmission is preferably driven with the output of the pilot transmission. The friction ring may be driven as a result of the pilot transmission driving the force return device. The larger or the outer ring of the friction rings is preferably driven. The force return device is particularly preferably rotatably fixedly connected to the larger of the two friction wheels.

In another specific embodiment, the smaller or the innermost ring of the two friction rings is rotatably mounted in relation to the force return device, in particular, via a roller bearing. In many cases, this enables a small ball bearing having a small diameter to be used for this function, which generates a low torque loss and is lightweight.

In another specific embodiment, the friction ring transmission includes a summation gear wheel, which is used to add the torque generated by muscle power and that which is motor-driven. The summation gear wheel may be rotatably fixedly connected to one of the two friction rings. It is rotatably fixedly connected preferably to the larger friction ring, which in one specific embodiment including a pilot transmission may mean that it is connected to the output of the pilot transmission. The summation takes place by introducing torques into the summation gear wheel in various ways, namely centrally by a shaft onto which the summation gear wheel is set and by an additional gear wheel, which engages in the outer circumference of the summation gear wheel. This additional gear wheel is preferably a gear wheel, which is drivable by the motor.

In another specific embodiment, a roller bearing is situated between the force return device and one of the friction wheels, in which the force transmission line is at an acute angle to the center axis of the roller carrier. Contact forces, which constitute axial forces, extend via the bearing between the friction rings and the rollers. In addition, it fulfills the function of a radial guide of the parts mounted rotatably relative to one another. For this reason, angular ball bearings or tapered roller bearings are preferably used. The force return device extends preferably in the interior of the roller bearing. The inner ring is preferably attached to or pressed onto the force return device. This enables a simple design of the friction ring transmission. The roller bearing advantageously runs at the differential rotational speed between the rotational speed of the inner friction ring and of the outer friction ring, which in many operating states is lower than the rotational speeds of the friction rings themselves. As a result, the bearing losses and the bearing wear are reduced compared to an approach according to the related art, in which the friction rings are supported individually on the housing with axial bearings.

In another aspect of the present invention, a vehicle operable using motor power and/or pedal power is provided, which includes a friction ring transmission according to one of the specific embodiments described above.

In still another aspect, a drive device is provided for a vehicle operable using motor power and/or pedal power, which includes a friction ring transmission according to one of the specific embodiments described above.

### BRIEF DESCRIPTION OF THE DRAWINGS

Exemplary embodiments of the present invention are described in detail below with reference to the figures.

FIG. 1 schematically shows a representation of an electric bicycle, which includes a specific embodiment of the friction ring transmission according to the present invention.

FIG. 2 shows a perspective view of an integrated drive unit including a friction ring transmission according to the present invention.

FIG. 3 shows a perspective view of the integrated drive unit in the specific embodiment shown in FIG. 2 without a housing surrounding the friction ring transmission.

FIG. 4 shows a cross section extending through a center axis of the roller carrier through the drive unit shown in FIG. 3 including the summation gear wheel, pilot transmission, friction ring transmission and rear transmission.

FIG. 5 shows an enlarged detail with a double tapered roller from the cross section shown in FIG. 4.

FIG. 6 shows a second specific embodiment of the drive unit, including a second specific embodiment of the friction ring transmission including a force return device designed as a sleeve and an angular ball bearing.

FIG. 7 shows a third specific embodiment of the drive unit, including a third specific embodiment of the friction ring transmission including a different force return device designed as a sleeve.

### DETAILED DESCRIPTION OF EXAMPLE EMBODIMENTS

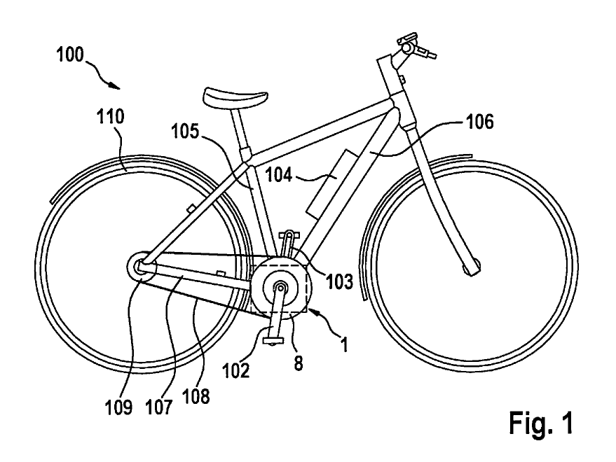

FIG. 1 schematically shows an electric bicycle 100, in which a drive unit 1 is situated centrally on the frame. Seat tube 105, down tube 106 and chain stay 107, in particular, converge at or near drive unit 1. The mounting of the crankshaft for pedal arms 102 and 103 is integrated into drive unit 1. The drive unit includes a chain ring 8, which constitutes the output of drive unit 1. Chain ring 8 transmits a torque from drive unit 1 via a chain 108 and a sprocket 109 to a rear wheel 110. Drive unit 1 includes an electric motor not explicitly shown. The electric motor may be supplied with power from a battery 104.

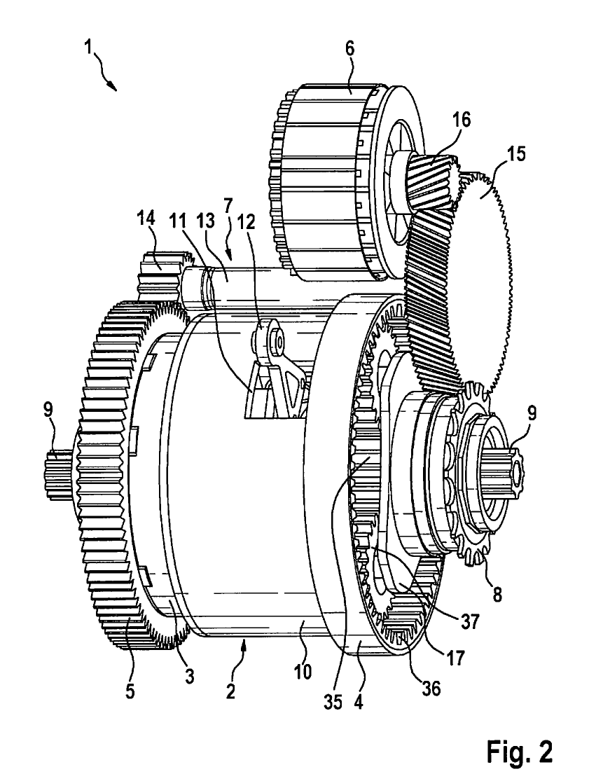

FIG. 2 shows a perspective view of an integrated drive unit 1, which includes a friction ring transmission 2, a pilot transmission 3, a rear transmission 4, a summation gear wheel 5, an electric motor 6, an intermediate transmission 7, an output 8 and a crankshaft 9. Crankshaft 9 is depicted without its cranks, each of which may be attached to a toothed connection at the end of crankshaft 9, other types of connections also being conceivable. Friction ring transmission 2 includes a housing 10, which at least radially surrounds friction ring transmission 2 except for an opening 11. An adjusting lever 12 as part of the friction ring transmission protrudes through opening 11 out of the interior of the housing. This adjusting lever is displaceable in the longitudinal direction of the crankshaft 9, as a result of which the gear ratio of friction ring transmission 2 is adjustable. The adjustment path of the adjusting device designed with adjusting lever 12 therefore extends in the inside of opening 11 and in the longitudinal direction of crankshaft 9 in relation to adjusting lever 12. The adjustment path is at least approximately linear.

Intermediate transmission 7 includes an intermediate shaft 13, at one end of which a sprocket 14 is situated, which meshes with summation gear wheel 5. The mounting of intermediate shaft 13 is not depicted. Sprocket 14 has a significantly smaller diameter than summation gear wheel 5. An intermediate gear wheel 15, which has a significantly larger diameter than sprocket 14, is situated at the other end of intermediate shaft 13. Intermediate gear wheel 15 meshes with an output gear wheel 16 of an electric motor 6, which is part of drive unit 1. This effectuates a significant reduction of the rotational speed of electric motor 6 relative to the rotational speed of summation gear wheel 5 via intermediate transmission 7. A mechanical connection between electric motor 6 and housing 10 of friction ring transmission 2 is not depicted.

Rear transmission 4 is designed as a planetary gear, the output of which is planet carrier 17. Planet carrier 17 is rotatably fixedly connected to output sprocket 8 of the integrated transmission unit. The planetary gear is driven by sun wheel 35, whereas annulus gear 36 is rotatably fixedly connected to housing 10. An outer cover of rear transmission 4 is not depicted, which may be designed to be fully covered.

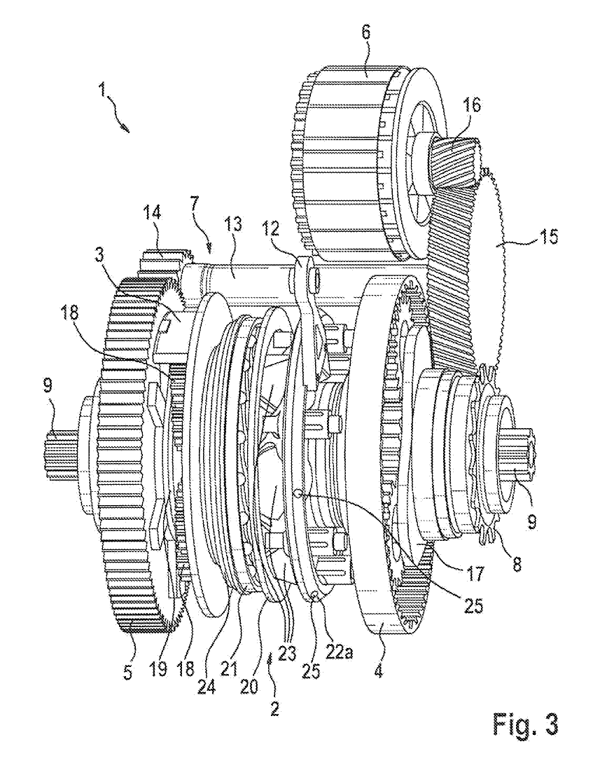

FIG. 3 shows a perspective view of the same integrated drive unit 1 as in FIG. 2, but with the difference that housing 10 of friction ring transmission 2 is omitted, so that its details are visible. A part of the annulus gear of pilot transmission 3 designed as a planetary gear is also omitted so that its planet wheels 18 and its planet carrier 19 are visible. Features and elements described in FIG. 1 are provided with the same reference numerals and are not separately described again. Reference is made to FIG. 1.

Friction ring transmission 2 includes an outer friction ring 20, which frictionally engages with multiple double cones 23. Double cones 23 are situated on a roller carrier 22 and revolve on axles 25 fastened thereto. Roller carrier 22 has a non-visible part located further inside of friction ring transmission 2. Outer friction ring 20 is connected to an expanding clutch 21 which, in turn, is supported via an axial bearing 24 on a housing part not depicted. Expanding clutch 21 expands in an axial direction of crankshaft 9 when a drive torque from summation gear wheel 5 acts on friction ring transmission 2. This increases the contact force between outer friction ring 20 and double tapered rollers 23. Adjusting lever 12 is connected to roller carrier 25, which is designed for displaceable movement in the axial direction of crankshaft 9. Expanding clutch 21 may include springs or may be connected to springs, which create a pretensioning force between outer friction ring 20 and double tapered rollers 23.

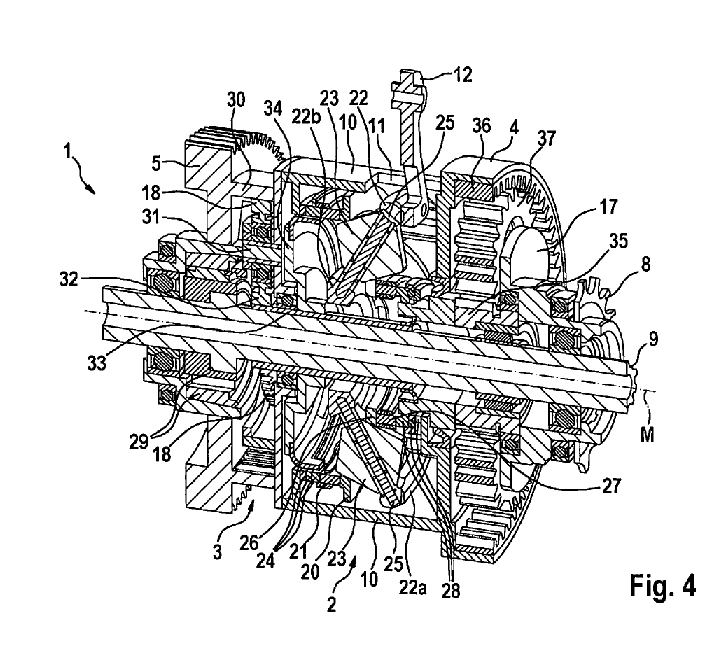

FIG. 4 shows a perspective view of a cross section through integrated drive unit 1, which is depicted in FIG. 3. The cross section extends through center axis M of crankshaft 9 and adjusting lever 12. Features and elements previously described in FIGS. 2 and 3 are identified by the same reference numerals and are not separately described again. Reference is made to FIGS. 2 and 3.

The interior part of roller carrier 22 is depicted in FIG. 4. This part is connected via roller axles 25 to the outer part of roller carrier 22. Also depicted is inner friction ring 26, which frictionally engages double cones 23. Inner friction ring 26 is assigned an expanding clutch 27, which is supported against housing 10 via an axial bearing 28. Expanding clutch 28, like expanding clutch 21, is designed in such a way that it is expanded when a drive torque acts on summation gear wheel 5 in the longitudinal direction of crankshaft 9, thereby increasing the contact force between inner friction ring 26 and double tapered rollers 23. Expanding clutch 27 may include springs or may be connected to springs, which create a pretensioning force between inner friction ring 26 and double tapered rollers 23. The diameter of expanding clutch 21 is smaller than that of expanding clutch 27.

The power flow through the part of drive unit 1 depicted in FIG. 4 is described below. A torque may be introduced into crankshaft 9 via not depicted cranks by pedal power. The torque in crankshaft 9 is introduced via a freewheel 29 into summation gear wheel 5. Freewheel 29 ensures that a reverse pedaling is possible while the remainder of the depicted transmissions revolves in accordance with the rotations of its output 8. Summation gear wheel 5 is rotatably fixedly connected to annulus gear 30 of pilot transmission 3, so that both revolve together. Planet wheels 18 of pilot transmission 3 are mounted on planet shafts 31, which are fastened to housing 10. Thus, the position of planet wheels 18, except for their inherent rotation, is fixed. Sun wheel 32 of the pilot transmission is rotatably fixedly connected to a sleeve 33, which conducts the torque from sun wheel 32 to friction ring transmission 2. Because of the gear ratio of pilot transmission 3, the rotational speed of sleeve 33 is greater than the rotational speed of summation gear wheel 5. Sleeve 33 is rotatably attached to crankshaft 9. A drive disk 34, which further conducts the torque from sleeve 33 via expanding clutch 21 to outer friction ring 20, is pressed onto sleeve 33. The torque is then transmitted to double tapered rollers 23. Since roller carrier 22 is not rotatable, but only displaceably situated in the longitudinal direction of crankshaft 9, the torque is completely transferred from outer friction ring 20 into a rotation of double tapered rollers 23. These transmit the torque further to inner friction ring 26, with which they also frictionally engage. The torque is transmitted via expanding clutch 27 further to sun wheel 35 of rear transmission 4. Annulus gear 36 of rear transmission 4 is rotatably fixedly connected to housing 10. Thus, the torque is transmitted to planet carrier 17 of planet wheels 37 of rear transmission 4. As previously mentioned, planet carrier 17 of rear transmission 4 is rotatably fixedly connected to output 8 designed preferably as a sprocket, so that the torque may be removed from integrated transmission unit 1 at this output, for example, via a chain.

Outer friction ring 20 and inner friction ring 26 are, as previously mentioned, supported on housing 10 by assigned axial bearings 24 and 28. Thus, housing 10 in the specific embodiment of FIGS. 1 through 3 forms a force return device for the forces originating, in particular, from expanding clutches 21 and 27. These forces correspond to the forces pressing on double tapered rollers 23. Axial bearings 24 and 28 run respectively at the rotational speed of large friction ring 20 and at the rotational speed of small friction ring 26. Axial bearing 24 of the large friction ring, in particular, generates a relatively high frictional torque, because it exhibits a high rotational speed and also a large friction radius in many operating states.

Crankshaft 9 is situated concentrically to roller carrier 22, axial bearings 24 and 28, expanding clutches 21 and 27 as well as to small friction ring 26 and large friction ring 20. Pilot transmission 3 and rear transmission 4, both of which are designed as planetary gears, are also situated concentrically to crankshaft 9. The same also applies for summation gear wheel 5 and the sprocket of output 8.

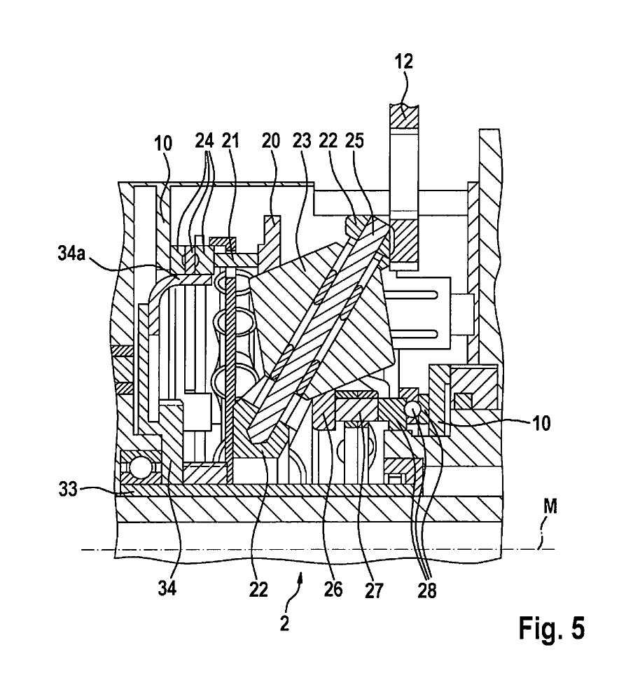

FIG. 5 shows a detail of the cross section depicted in perspective view in FIG. 4, which includes friction ring transmission 2, in a view shown as a half section. Identical features and elements are identified by identical reference numerals and are not described separately again. Reference is made in this regard to FIG. 4. In FIG. 5, it is clearly apparent that drive disk 34 includes an edge 34a bent in the axial direction, via which torque is conducted from sleeve 33 to expanding clutch 21.

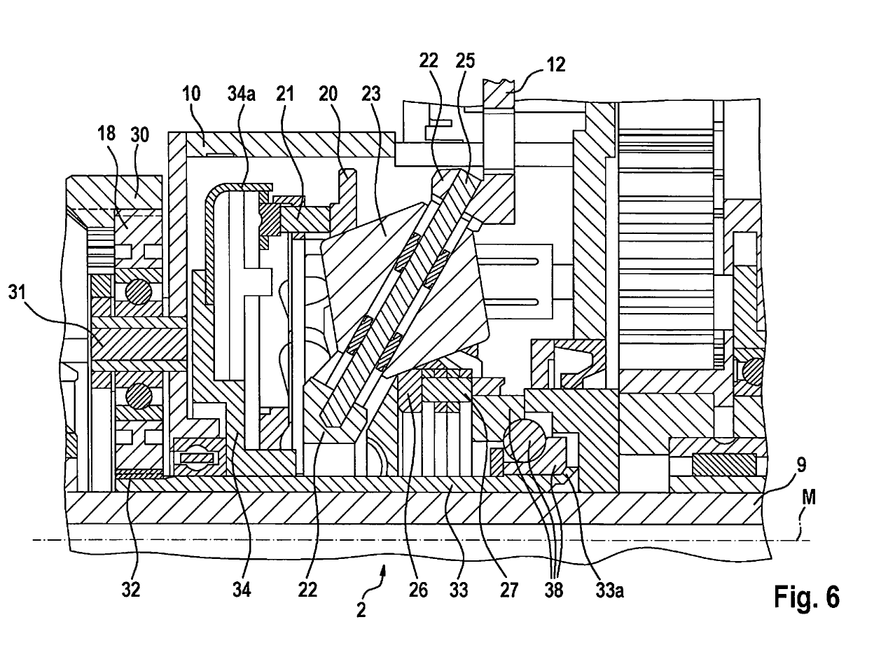

FIG. 6 shows a somewhat larger detail of the view shown in FIG. 5, but with the difference that FIG. 6 shows a second specific embodiment of drive unit 1 having a second specific embodiment of friction ring transmission 2. Identical features and elements are identified by the same reference numerals as in the previously described figures and are not described separately again.

Unlike the first specific embodiment shown in FIG. 5, the second specific embodiment in FIG. 6 shows no axial bearings 24 and 28, with which the friction ring transmission is supported on housing 10. Instead, sleeve 33, which is fitted in the second specific embodiment with an axial force absorption section 33a, serves as a force return device. The force exerted by inner friction ring 26 on double tapered rollers 23 is transmitted via expanding clutch 27 to an angular ball bearing 38. This angular ball bearing 38 is attached or pressed with its inner ring onto sleeve 33. One edge of an axial surface of the inner ring of angular ball bearing 38 is supported axially on axial force absorption section 33a of sleeve 33. The axial forces, which correspond to the contact forces on the double tapered rollers 23, are conducted by the sleeve further to pressure disk 34, which conducts them via its axial section 34a further to expanding clutch 21 and to outer friction ring 20. In this way, the power flow, with which double cone 23 is clamped, is closed off. Angular ball bearing 38 revolves at the differential speed of outer friction ring 20 and of inner friction ring 26. This rotational speed is lower in many operating states than the rotational speed of inner or outer friction rings 26, 21, compared to housing 10, which preserves the bearing.

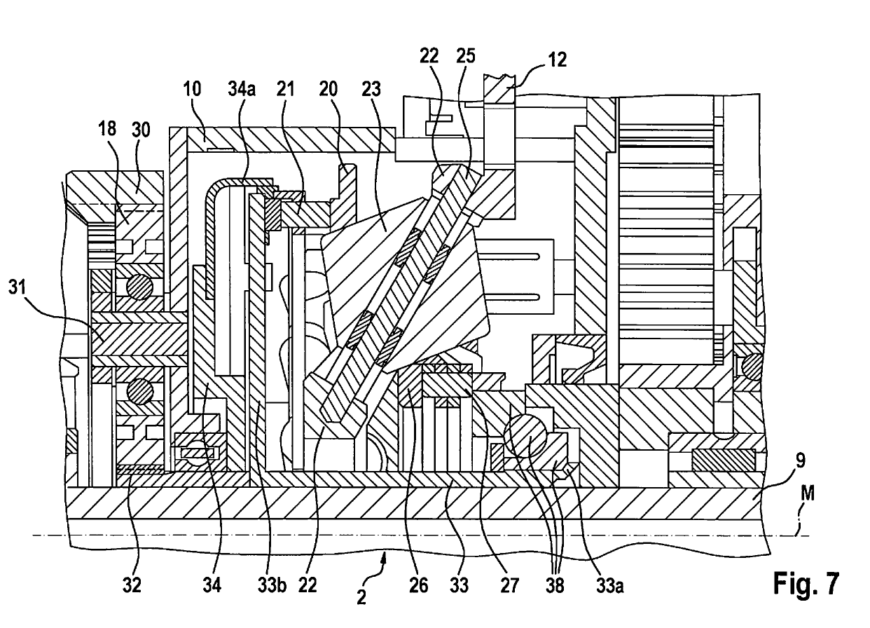

FIG. 7 shows the same view of a cross section of friction ring transmission 2 in half-section as in FIG. 6, but with the difference that in FIG. 7, a third specific embodiment of friction ring transmission 2 is depicted. Identical features and elements are identified by identical reference numerals and are not described separately again. Reference is made to FIG. 5 and to the previously described figures.

Unlike the specific embodiment of FIG. 6, the force return device in the specific embodiment of FIG. 7 is implemented with an integrally designed sleeve 33, which includes a radially extending section 33b, which is part of the force return device. Drive disk 34 is therefore not loaded or barely loaded by the returning contact force of the friction rings and may transmit as its main load the torque from sun wheel 32 of the pilot transmission to large friction ring 20. A more reliable fail-safe operation results from the integral design of sleeve 33 with its radially projecting section 33b, because an alternative conceivable connection between drive disk 34 and sleeve 33 cannot fail due to its integral design.

1-17. (canceled)

18. A friction ring transmission for a vehicle operable using motor power and/or pedal power, the vehicle including a crankshaft for pedal cranks, the friction ring transmission comprising:
an inner friction ring and an outer friction ring;
at least one rotatable double tapered roller situated on a roller carrier, which frictionally engages with the inner friction ring and the outer friction ring, in each case with a contact force, when a torque is transmitted via the friction ring transmission;
a force return device for transmitting a contact force from one of the inner and outer friction rings to the other of the inner and outer friction rings, the force return device situated in a power flow path from the inner friction ring to the outer friction ring, one of the inner and outer friction rings being rotatably fixedly situated in relation to the force return device and the other of the inner and outer friction rings being rotatably situated in relation to the force return device; and
an adjusting device to adjust a gear ratio, the adjusting device being movable along an adjustment path which extends in the direction of a center axis of the inner and outer friction rings, the adjusting device extending less than 360 degrees around a center axis of the roller carrier.

19. The friction ring transmission as recited in claim 18, wherein the vehicle is an electric bicycle.

20. The friction ring transmission as recited in claim 18, wherein the force return device extends inside the inner and outer friction rings.

21. The friction ring transmission as recited in claim 18, wherein the adjusting device extends through a section of a housing of the friction ring transmission and is rotatably fixedly connected to the roller carrier.

22. The friction ring transmission as recited in claim 21, wherein the roller carrier, the adjusting device, and at least one section of the housing of the friction ring transmission, are non-rotatingly situated and the adjusting device, which is fitted as an arm originating from the roller carrier and movable along the adjustment path, extends through the section of the housing.

23. The friction ring transmission as recited in claim 21, further comprising:
a servomotor for adjusting the adjusting device.

24. The friction ring transmission as recited in claim 18, further comprising:
two annular expanding clutches through which the force return device extends, at least one of the expanding clutches being situated between the force return device and one of the inner and outer friction rings.

25. The friction ring transmission as recited in claim 18, wherein the force return device is situated around the crankshaft and is an integral sleeve.

26. The friction ring transmission as recited in claim 18, wherein the force return device includes a section extending radially away from the crankshaft wherein the section is for connecting to one of the friction rings or the section is integrally designed with one of the inner and outer friction rings.

27. The friction ring transmission as recited in claim 18, wherein a pilot transmission, which increases a speed of the friction wheel transmission relative to the drive speed of the pilot transmission, is connected in front of the friction ring transmission, the pilot transmission being a planetary gear.

28. The friction ring transmission as recited in claim 18, wherein the force return device is rotatably fixedly connected to a drive element of the friction ring transmission.

29. The friction ring transmission as recited in claim 28, wherein the drive element is a shaft or a gear wheel.

30. The friction ring transmission as recited in claim 28, wherein the drive element is an output sun wheel of a planetary gear.

31. The friction ring transmission as recited in claim 18, wherein a smaller one of the inner and outer friction rings is rotatably situated relative to the force return device.

32. The friction ring transmission as recited in claim 27, further comprising:
a summation gear wheel for summing torques of the crankshaft and an electric motor, on a drive of the pilot transmission or of the friction ring transmission.

33. The friction ring transmission as recited in claim 18, wherein the inner friction ring and the outer friction ring are situated circumferentially around the crankshaft.

34. The friction ring transmission as recited in claim 18, wherein a roller bearing is situated between the force return device and one of the inner and outer friction rings, in which a pressure line to raceways between contact points of a roller body is at an acute angle to the center axis of the roller carrier, the roller bearing being as an angular ball bearing or a tapered roller bearing.

35. The friction ring transmission as recited in claim 34, wherein the force return device is radially surrounded by the roller bearing, the inner raceway of the roller bearing being situated on an outer surface of the force return device and is axially supported on the outer surface.

36. A vehicle operable using motor power and/or pedal power, the vehicle having a friction ring transmission including:
an inner friction ring and an outer friction ring;
at least one rotatable double tapered roller situated on a roller carrier, which frictionally engages with the inner friction ring and the outer friction ring, in each case with a contact force, when a torque is transmitted via the friction ring transmission;
a force return device for transmitting a contact force from one of the inner and outer friction rings to the other of the inner and outer friction rings, the force return device situated in a power flow path from the inner friction ring to the outer friction ring, one of the inner and outer friction rings being rotatably fixedly situated in relation to the force return device and the other of the inner and outer friction rings being rotatably situated in relation to the force return device; and
an adjusting device to adjust a gear ratio, the adjusting device being movable along an adjustment path which extends in the direction of a center axis of the inner and outer friction rings, the adjusting device extending less than 360 degrees around a center axis of the roller carrier.

37. The vehicle as recited in claim 36, further comprising:
a servomotor for adjusting the adjusting device.
